(19) United States
(12) Patent Application Publication
(10) Pub. No.: US 2009/0059594 A1
(43) Pub. Date: Mar. 5, 2009

(54) Heat dissipating apparatus for automotive LED lamp

(76) Inventor: Ming-Feng Lin, Tainan (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/896,323

(22) Filed: Aug. 31, 2007

(51) Int. Cl. F21V 29/02

(52) U.S. Cl. 362/294

(57) ABSTRACT

In a heat dissipating apparatus for an automotive LED lamp, the automotive LED lamp includes an automotive lamp set, a heat dissipating module, a plurality of LEDs, and a reflecting unit. The heat dissipating module is wrapped to form an insulation circuit for separating heat energy and electric power of the insulation circuit and heat dissipating module. The LED is electrically connected to the insulation circuit, and a main base of the LED installs a metal conducting plate for conducting the heat produced by the LED to the heat dissipating module. The reflecting unit is installed in the automotive lamp set, so that the heat dissipating module can use a cold air or a liquid coolant as the heat dissipating medium for dissipating heat, preventing a drop of light output caused by an overheat, and avoiding damages to the LED to extend the life expectancy of the automotive LED lamp.

### FIELD OF THE INVENTION

The present invention relates to a heat dissipating apparatus for an automotive light emitting diode (LED) lamp, and more particularly to a structural design of a heat dissipating apparatus for an automotive LED lamp.

### BACKGROUND OF THE INVENTION

In general, light emitting objects used for automotive lamps can be divided into three main types: halogen light bulb, xeon light bulb and light emitting diode (LED). Particularly, the LED technology can provide a high brightness, but it still needs several LEDs to provide sufficient brightness and meet the requirements of related laws and specifications of the automotive lamps, if LED is applied to automotive lamp. However, the light emitting efficiency of the LED just occupies 20% of the inputted energy, and approximately 80% of the inputted energy is released in form of heat energy, and thus a high percentage of the power is consumed for producing heat energy. If several LEDs are applied to an automotive lamp, the produced heat energy will be large, and the light output will be reduced or the LED may even be damaged due to the overheating of the LED when the heat energy produced by the LED cannot be eliminated by an effective method.

In view of the shortcomings of the prior art, the inventor of the present invention based on years of experience in the related industry to conduct extensive researches and experiment to overcome the aforementioned shortcomings of applying LEDs to automotive lamps, and finally developed a heat dissipating apparatus for an automotive LED lamp in accordance with the present invention.

### SUMMARY OF THE INVENTION

Therefore, it is a primary objective of the present invention to provide a heat dissipating apparatus for automotive LED lamp, and the automotive LED lamp installs a heat dissipating module that uses a cold air or a liquid coolant as a medium for dissipating the heat energy produced by the LED, preventing an overheat of the LED of the automotive LED lamp, a decrease of light output or even a damage to the LED, and extending the life expectancy of the automotive LED lamp.

To achieve the foregoing objective, the present invention provides a heat dissipating apparatus for an automotive LED lamp, and the heat dissipating apparatus is fixed to an automobile body and electrically connected to an automotive LED lamp driving circuit in the automobile body. The automotive LED lamp comprises: an automotive lamp set having a base and a lamp housing, and the lamp housing is a light transmitting body fixed at the front of the base; a heat dissipating module connected to the base of the automotive lamp set and having a plurality of fins, and an insulation circuit formed at an appropriate position of the heat dissipating module, so that the insulation circuit will not be electrically connected to a main body of the heat dissipating module; a plurality of LEDs electrically connected to the insulation circuit of the heat dissipating module, and the LED includes a main base, and the main base has a metal conducting plate, for conducting the heat energy produced by the LED to the heat dissipating module; a reflecting unit installed inside the base of the automotive lamp set, such that the LED can be fixed to the bottom of the reflecting unit for reflecting the light projected from the LED, and refracting the light towards the lamp housing to comply with the brightness and light pattern as specified by related laws and regulations for the control of automotive lamp.

To achieve the foregoing objective, the present invention provides another heat dissipating apparatus for automotive LED lamp, and the heat dissipating apparatus is fixed to the automobile body and electrically connected to an automotive LED lamp driving circuit in the automobile body. The automotive LED lamp comprises: an automotive lamp set having a base and a lamp housing, and the lamp housing is a light transmitting body fixed at the front of the base; a plurality of light emitting modules fixed at a base of the automotive lamp set, and the light emitting module includes a light emitting unit, a reflecting unit, a lens unit and a heat dissipating unit, and the light emitting unit includes an LED and a substrate, and the substrate is formed by connecting a heat dissipating board to a circuit board, and the circuit board is provided for electrically connecting the LED, and the reflecting unit is provided for installing the light emitting unit at the bottom of the reflecting unit and reflecting a light projected by the LED, and the lens unit is installed at the front of the reflecting unit, and the heat dissipating unit is fixed with the light emitting unit, and the heat dissipating unit includes a thermoelectric cooling chip and a heat dissipating fin, and the thermoelectric cooling chip is connected with the light emitting unit, for lowering the temperature of the light emitting unit, and the heat dissipating fin is connected to the thermoelectric cooling chip, for lowering the temperature of a hot end of a body of the thermoelectric cooling chip.

### BRIEF DESCRIPTION OF THE DRAWINGS

FIG. 1 is a cross-sectional view of a heat dissipating apparatus for automotive LED lamp in accordance with a first preferred embodiment of the present invention;

FIG. 2 is a cross-secitonal view of a heat dissipating module fin installed at the bottom of a heat dissipating apparatus for automotive LED lamp in accordance with a first preferred embodiment of the present invention;

FIG. 3 is a cross-sectional view of a heat dissipating apparatus for automotive LED lamp in accordance with a second preferred embodiment of the present invention;

FIG. 4 is cross-sectional view of a heat dissipating module of a heat dissipating apparatus for automotive LED lamp having a groove for embedding and fixing a reflecting unit in accordance with a second preferred embodiment of the present invention;

FIG. 5 is a cross-sectional view of a heat dissipating apparatus for automotive LED lamp in accordance with a third preferred embodiment of the present invention;

FIG. 6 is a cross-sectional view of a heat dissipating module and an LED module of a heat dissipating apparatus for automotive LED lamp in accordance with a third preferred embodiment of the present invention;

FIG. 7 is a cross-sectional view of a heat dissipating apparatus for automotive LED lamp in accordance with a fourth preferred embodiment of the present invention;

FIG. 8 is a horizontal cross-sectional view of an automotive LED lamp of the present invention;

FIG. 9A is a schematic diagram of a thermoelectric cooling chip, a rectification circuit and a heat dissipating fan in accordance with a heat dissipating apparatus for automotive LED lamp in accordance with a fourth preferred embodiment of the present invention;

FIG. 9B is another schematic diagram of a thermoelectric cooling chip, a rectification circuit and a heat dissipating fan in accordance with a heat dissipating apparatus for automotive LED lamp in accordance with a fourth preferred embodiment of the present invention, and the dotted arrow in FIG. 9B indicates the direction of current;

FIG. 10 is a cross-sectional view of a heat dissipating apparatus for automotive LED lamp in accordance with a fifth preferred embodiment of the present invention;

FIG. 11 is a cross-sectional view of a heat dissipating apparatus for automotive LED lamp in accordance with a sixth preferred embodiment of the present invention;

FIG. 12 is a cross-sectional view of a heat dissipating apparatus for automotive LED lamp in accordance with a seventh preferred embodiment of the present invention;

FIG. 13 is a perspective view of a heat dissipating module and an LED module of a heat dissipating apparatus for automotive LED lamp in accordance with a seventh preferred embodiment of the present invention;

FIG. 14 is a schematic view of an application of a heat dissipating apparatus for automotive LED lamp in accordance with a seventh preferred embodiment of the present invention;

FIG. 15 is a cross-sectional view of a heat dissipating apparatus for automotive LED lamp in accordance with an eighth preferred embodiment of the present invention;

FIG. 16 is a cross-sectional view of a heat dissipating apparatus for automotive LED lamp in accordance with a ninth preferred embodiment of the present invention;

FIG. 17 is a cross-sectional exploded view of an optical module of FIG. 16;

FIG. 18 is a cross-sectional view of a shading unit installed between a lens unit and a reflecting unit as depicted in FIG. 16;

FIG. 19 is a cross-sectional view of an application of a heat dissipating apparatus for automotive LED lamp in accordance with a tenth preferred embodiment of the present invention; and

FIG. 20 is a horizontal cross-sectional view of an automotive LED lamp as depicted in FIG. 18.

### DETAILED DESCRIPTION OF THE PREFERRED EMBODIMENTS

To make it easier for our examiner to understand the technical characteristics of the invention, we use a preferred embodiment together with the attached drawings for the detailed description of the invention.

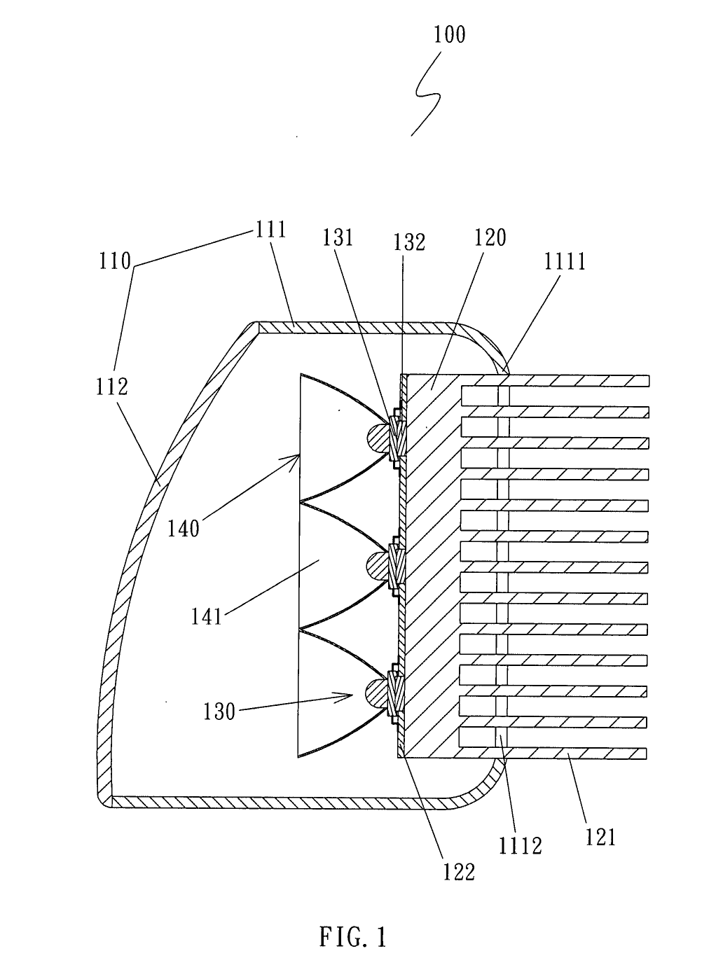

Referring to FIG. 1 for a cross-sectional view of a heat dissipating apparatus for automotive LED lamp in accordance with a first preferred embodiment of the present invention, the automotive LED lamp 100 comprises an automotive lamp set 110, a heat dissipating module 120, a plurality of LEDs 130, and a reflecting unit 140.

The automotive lamp set 110 is mounted to an automobile body, and the automotive lamp set 110 includes a base 111 and a lamp housing 112, and the lamp housing 112 could be a light transmitting body fixed at the front of the base 111, and having a through hole 1112 disposed at a rear lateral side 1111 of the base 111 for passing the heat dissipating module 120.

The heat dissipating module 120 is made of a metal, ceramic or other material with a high thermal conduction coefficient and the heat dissipating module 120 is a plurality of fins 121 aligned horizontally (the design of the fins 121 of the heat dissipating module 120 may vary according to the space of the automotive lamp set, the space of the automobile body and the shape and stylish design of the automotive lamp), and an insulation circuit 122 coated at a lateral side of the heat dissipating module 120 which is away from the fin 121 for electrically connecting the LED 130, and the insulation circuit 122 has a plurality of penetrating holes, and the insulation circuit 122 is thermoelectrically separated from the heat dissipating module 120, such that the insulation circuit 122 will not be electrically connected with the heat dissipating module 120, and the insulation circuit 122 will not affect the heat conduction between the LED 130 and the heat dissipating module 120, and the heat dissipating module 120 has a through hole 1112 of a base 111 of the automotive lamp set 110 disposed at a position facing a lateral side with the insulation circuit 122 and connected to the automotive lamp set 110, such that the insulation circuit 122 of the heat dissipating module 120 is situated inside the automotive lamp set 110. In the meantime, the fins 121 of the heat dissipating module 120 are situated on the external side of the automotive lamp set 110.

The LED 130 is electrically connected to the insulation circuit 122 of the heat dissipating module 120 and used as a light source for the automotive lamp, and the LED 130 has a main base 131, and the main base 131 has a metal conducting plate 132 for electrically connecting the LED 130 with the insulation circuit 122 of the heat dissipating module 120, and a metal conducting plate 132 of the LED 130 is passed through a penetrating hole of the insulation circuit 122, such that the metal conducting plate 132 and the heat dissipating module 120 are in contact with each other, and the heat energy produced by the LED 130 is conducted to the heat dissipating module 120.

The reflecting unit 140 forms a plurality of grooves 141 electrically connected to the corresponding LED 130 of the insulation circuit 122, so that the LED 130 is situated at the bottom of the corresponding groove 141 of the reflecting unit 140 for reflecting the light projected by the LED 130 through the reflecting unit 140, and the light is refracted towards the lamp housing 112 to the outside, such that the position of the projected light can comply with the brightness and light pattern as set forth in the related laws and regulations of the automotive lamp.

During installation, the plurality of LEDs 130 are electrically connected to the insulation circuit 122 of the heat dissipating module 120, and the metal conducting plate 132 of the LED 130 is passed through the penetrating hole of the insulation circuit 122, so that the metal conducting plate 132 and the heat dissipating module 120 are in contact with each other, and the heat dissipating module 120 has a through hole 1112 disposed on a lateral side of the insulation circuit 122 facing the base 111, and the heat dissipating module 120 is connected to the base 111, and the fins 121 of the heat dissipating module 120 are situated at the external side of the automotive lamp set 110, and the insulation circuit 122 is electrically connected to an automotive LED lamp driving circuit (not shown in the figure) of the automobile body, and the groove 141 of the reflecting unit 140 is corresponsive with the LED 130, such that the LED 130 is situated at the bottom of the groove 141 of the reflecting unit 140, and the reflecting unit 140 is connected to the heat dissipating module 120, and finally the lamp housing 112 is fixed at the front of the base 111 to complete the installation of the automotive LED lamp 100. In the meantime, the automotive LED lamp 100 is mounted to the automobile body.

During use, the LED 130 is electrically connected to produce light, and the light is reflected from the reflecting unit 140 and refracted towards the lamp housing 112 to the outside, such that the position of the projected light can comply with the brightness and light pattern as set forth in the related laws and regulations of the automotive lamp. In the meantime, the LED 130 also produces heat energy. The heat energy of the LED 130 is conducted by the metal conducting plate 132 of the LED 130 to the heat dissipating module 120, and the heat dissipating module 120 conducts the heat energy to the fins 121 at an external side of the automotive lamp set 110, and the fin 121 is in contact with cold air, so that the heat energy is absorbed by the cold air, so as to achieve the heat dissipating effect of the heat dissipating module 120.

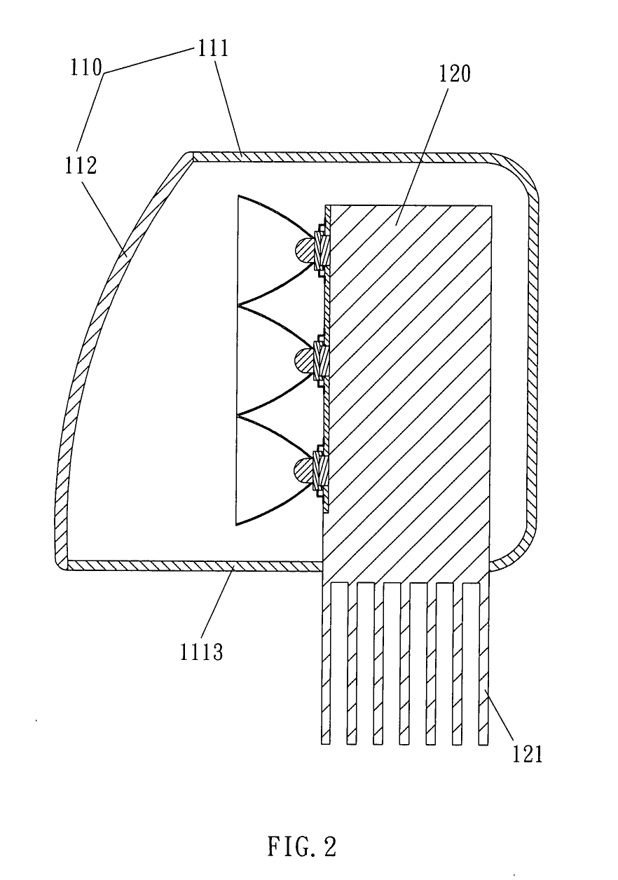

The plurality of fins 121 of the heat dissipating module 120 in accordance with the first preferred embodiment can be situated under the body of the heat dissipating module 120, and the automotive lamp set 110 has a through hole at a bottom surface 1113 for passing the fin 121 of the heat dissipating module 120, such that the fins 121 are situated at the external side of the automotive lamp set 110 as shown in FIG. 2, so as to achieve the same heat dissipating effect of the first preferred embodiment.

The second preferred embodiment of the present invention is partially the same as the first preferred embodiment, and thus the same elements are represented by the same respective numerals and assumed to have identical structures and functions, unless stated otherwise.

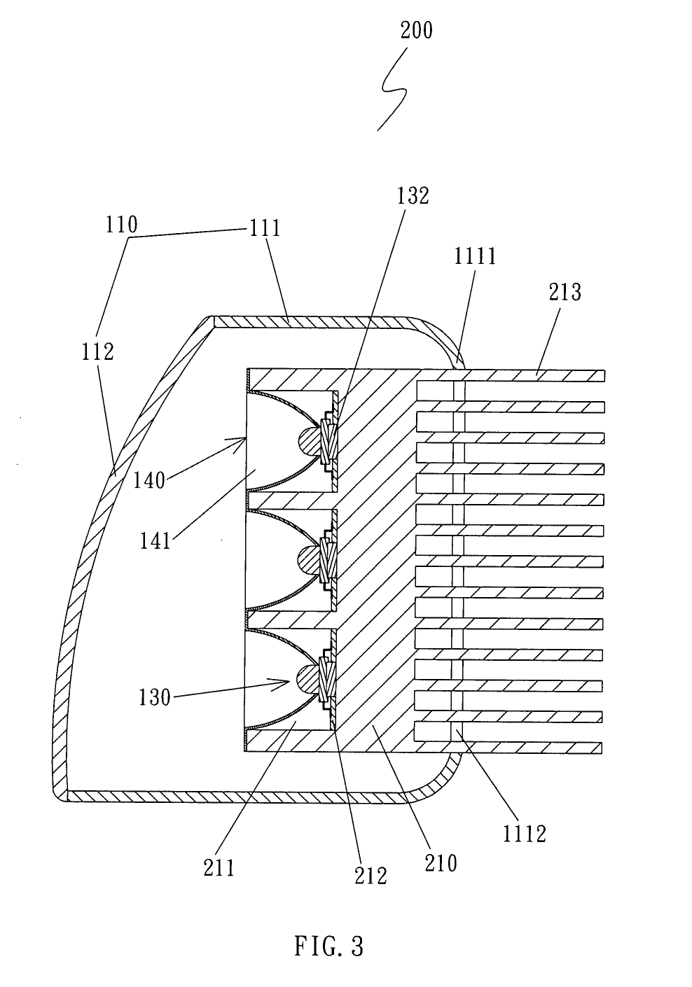

Referring to FIG. 3 for a cross-sectional view of a heat dissipating apparatus for an automotive LED lamp in accordance with a second preferred embodiment of the present invention, the second preferred embodiment, the automotive LED lamp 200 comprises an automotive lamp set 110, a heat dissipating module 210, a plurality of LEDs 130, and a reflecting unit 140, wherein the main difference resides on that the heat dissipating module 210 has a plurality of grooves 211, and an insulation circuit 212 is coated and formed at the bottom surface of the groove 211 for electrically connecting the LED 130, and the insulation circuit 212 has a penetrating hole, and the heat dissipating module 210 has a plurality of fins 213, and the reflecting unit 140 has a plurality of grooves 141, such that the groove 141 of the reflecting unit 140 is corresponsive to the groove 211 of the heat dissipating module 210, for embedding and fixing the groove 141 of the reflecting unit 140 into the groove 211 of the heat dissipating module 210.

During installation, the plurality of LEDs 130 are electrically connected to the insulation circuit 212 of the heat dissipating module 210, and a metal conducting plate 132 of the LED 130 is passed through a penetrating hole of the insulation circuit 212, such that the metal conducting plate 132 and the heat dissipating module 210 are in contact with each other, and the heat dissipating module 210 has a through hole 1112 at a lateral side of the insulation circuit 212 facing the rear lateral side 1111 of the base 111, and the heat dissipating module 210 is connected to the automotive lamp set 110, and the fins 213 of the heat dissipating module 210 are situated at the external side of the automotive lamp set 110, and the insulation circuit 212 is electrically connected to an automotive LED lamp driving circuit (not shown in the figure) of the automobile body, and a groove 141 the reflecting unit 140 corresponds to the LED 130, such that the reflecting unit 140 is connected to the heat dissipating module 210, and the LED 130 is situated at the bottom of the groove 141 of the reflecting unit 140, and finally the lamp housing 112 is fixed at the front of the automotive lamp set 110 to complete the installation of the automotive LED lamp 200. In the meantime, the automotive LED lamp 200 is mounted to the automobile body.

During use, the LED 130 is electrically connected to produce light, and the light is reflected from the reflecting unit 140 and refracted towards the lamp housing 112 to the outside, such that the position of the projected light can comply with the brightness and light pattern as set forth in the related laws and regulations of the automotive lamp. In the meantime, the LED 130 also produces heat energy. The heat energy of the LED 130 is conducted by a conducting plate 132 of the LED 130 to the heat dissipating module 210, and the heat dissipating module 210 conducts the heat energy to the fins 213 situated at the external side of the automotive lamp set 110. With the contact of the fins 213 and cold air, the heat energy is absorbed by the cold air, so as to achieve the heat dissipating effect of the heat dissipating module.

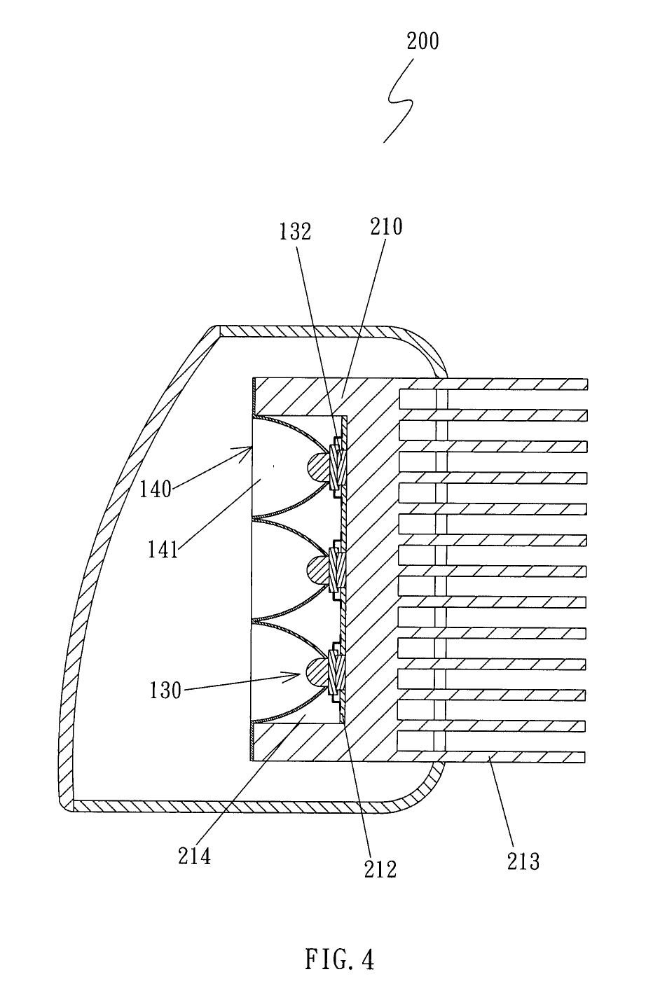

The heat dissipating module 210 in accordance with the second preferred embodiment of the present invention also has a groove 214 for embedding and fixing the reflecting unit 140, and an insulation circuit 212 coated and formed on the bottom surface of the groove 214 for electrically connecting a plurality of LEDs 130. In the meantime, the insulation circuit 212 forms a plurality of penetrating holes, for passing the metal conducting plate 132 of the LED 130, such that the metal conducting plate 132 and the heat dissipating module 210 are in contact with each other, and the heat dissipating module 210 has a plurality of fins 213, and the reflecting unit 140 forms a plurality of grooves 141, such that the grooves 141 are electrically connected to the corresponding LEDs 130 of the insulation circuit 212, and the LEDs 130 are situated at the bottom corresponding to the groove 141 of the reflecting unit 140, and the reflecting unit 140 is connected to the heat dissipating module 210 as shown in FIG. 4, so as to achieve the same heat dissipating effect as described in the second preferred embodiment.

The third preferred embodiment of the present invention is partially the same as the first preferred embodiment, and thus the same elements are represented by the same respective numerals and assumed to have identical structures and functions, unless stated otherwise.

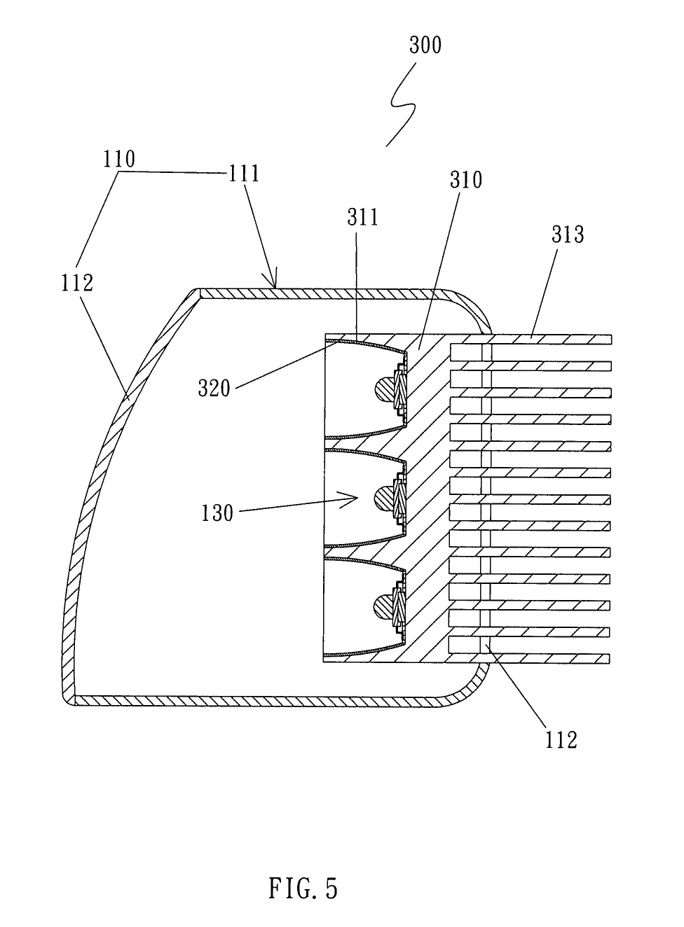

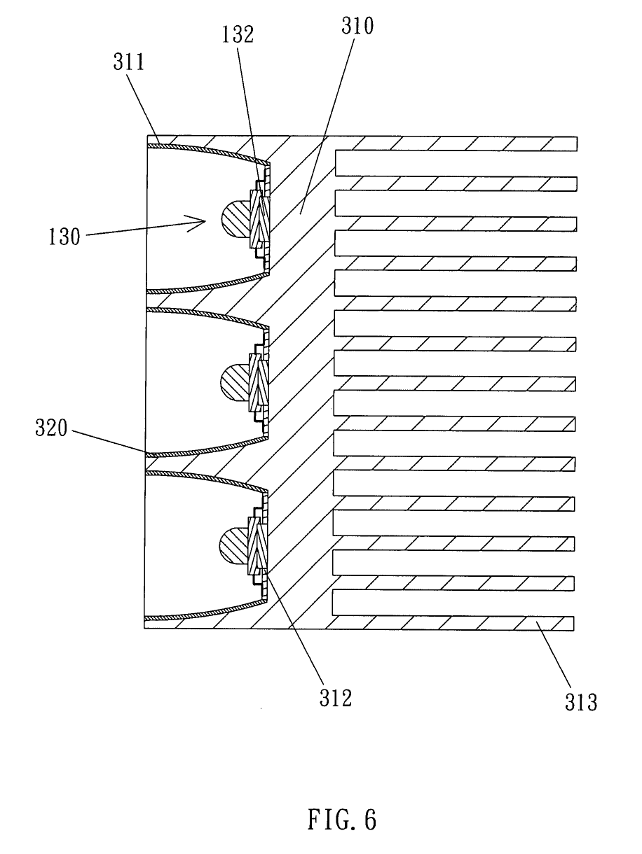

Referring to FIGS. 5 and 6 for a cross-sectional view of a heat dissipating apparatus for automotive LED lamp and a cross-sectional view of a heat dissipating module and an LED in accordance with a third preferred embodiment of the present invention, the automotive LED lamp 300 of the third preferred embodiment comprises an automotive lamp set 110, a heat dissipating module 310, a plurality of LEDs 130, and a plurality of reflecting units 320, wherein the main difference resides on that the heat dissipating module 310 has a plurality of grooves 311, and an insulation circuit 312 coated and formed at the bottom surface of the groove 311 for electrically connecting the LED 130. In the meantime, the insulation circuit 312 forms a penetrating hole, and the heat dissipating module 310 has a plurality of fins 313, and the reflecting unit 320 is electroplated onto an internal surface of the groove 311 of the heat dissipating module 310, such that the light projected by the LED 130 is reflected by the reflecting unit 320 and refracted towards the lamp housing 112 to the outside, such that the position of the projected light can comply with the brightness and light pattern as set forth in the related laws and regulations of the automotive lamp.

During installation, the plurality of LEDs 130 are electrically connected to the insulation circuit 312 of the heat dissipating module 310, and the metal conducting plate 132 of the LED 130 is passed through the penetrating hole of the insulation circuit 312, such that the metal conducting plate 132 and the heat dissipating module 310 are in contact with each other, and the heat dissipating module 310 has a through hole 1112 disposed on a lateral side of the insulation circuit 312 facing the base 111, so that the heat dissipating module 310 is connected to the base 111 of the automotive lamp set 110, and the fins 313 of the heat dissipating module 310 are situated at an external side of the automotive lamp set 110, and the insulation circuit 312 is electrically connected to an automotive LED lamp driving circuit (not shown in the figure of the automobile body, and finally the lamp housing 112 is fixed at the front of the base 111 to complete the installation of the automotive LED lamp 300. In the meantime, the automotive LED lamp 300 is mounted onto the automobile body.

During use, the LED 130 is electrically connected to produce light, and the light is reflected from the reflecting unit 320 formed at the groove 311 of the heat dissipating module 310 and refracted towards the lamp housing 112 to the outside, such that the position of the projected light can comply with the brightness and light pattern as set forth in the related laws and regulations of the automotive lamp. In the meantime, the LED 130 also produces heat energy. The heat energy of the LED 130 is conducted by the metal conducting plate 132 of the LED 130 to the heat dissipating module 310, and the heat dissipating module 310 conducts the heat energy to the fins 313 situated at the external side of the automotive lamp set 110. With the contact of the fin 313 and cold air, the heat energy is absorbed by the cold air, so as to achieve the heat dissipating effect of the heat dissipating module 310.

The fourth preferred embodiment of the present invention is partially the same as the first preferred embodiment, and thus the same elements are represented by the same respective numerals and assumed to have identical structures and functions, unless stated otherwise.

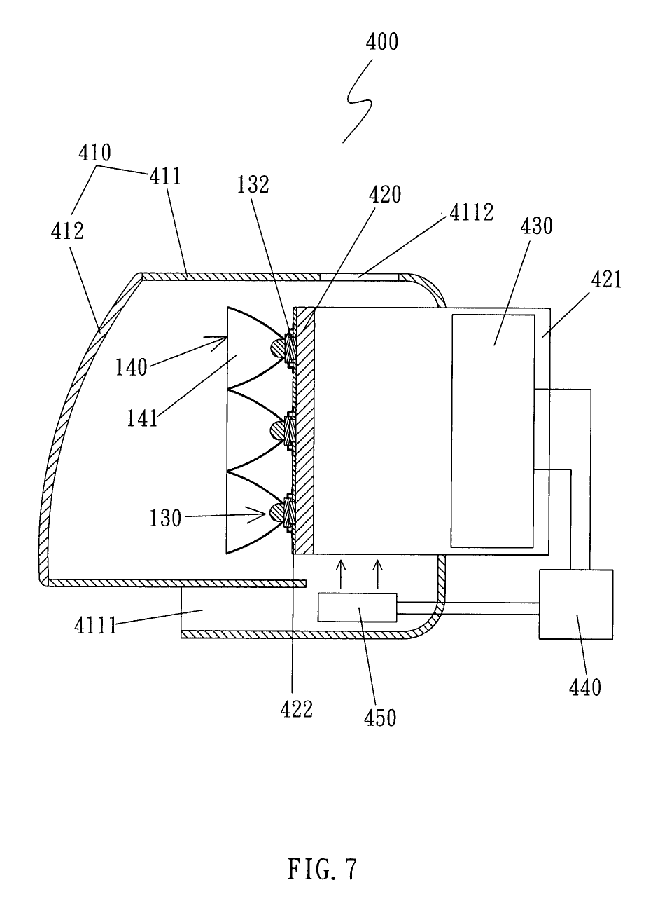

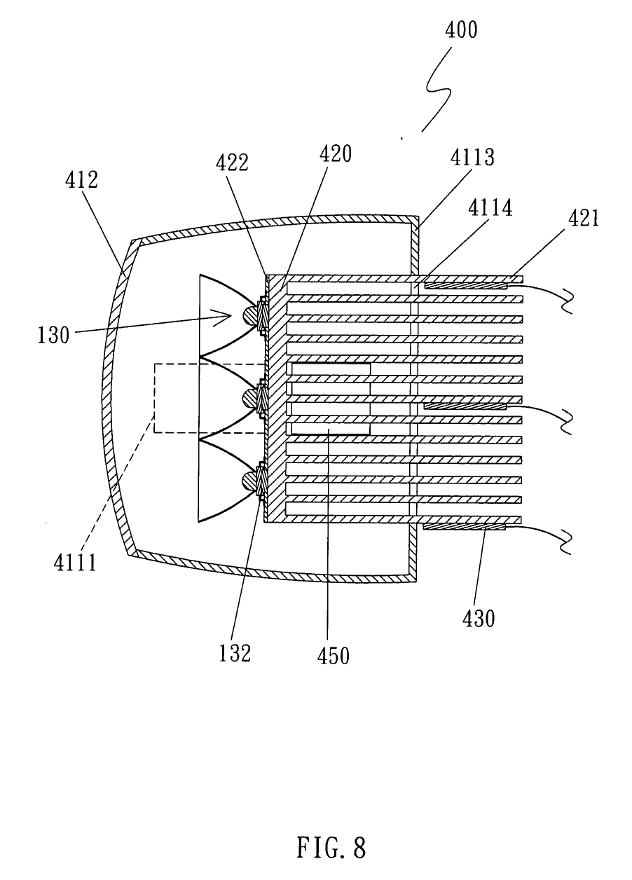

Referring to FIGS. 7 and 8 for a cross-sectional view of a heat dissipating apparatus for automotive LED lamp of a fourth preferred embodiment and a horizontal cross-sectional view of an automotive LED lamp in accordance with the present invention, the automotive LED lamp 400 of the fourth preferred embodiment comprises an automotive lamp set 410, a heat dissipating module 420, a plurality of LEDs 130, a reflecting unit 140, a plurality of thermoelectric cooling chip 430 (This embodiment just shows three thermoelectric cooling chips 430 in the figure for the illustration), at least one rectification circuit 440, and at least one heat dissipating fan 450 (This embodiment just shows one heat dissipating fan 450 in the figure for the illustration), wherein the main difference resides on that the automotive lamp set 410 includes a base 411 and a lamp housing 412, and the bottom surface of the base 411 has at least one air-guide channel 4111, while the top surface of the base 411 has at least one ventilation hole 4112 (wherein the ventilation hole 4112 also comes with a rear lateral side 4113 of the base 411), and the rear lateral side 4113 of the base 411 has a through hole 4114 for passing the heat dissipating module 420; the heat dissipating module 420 has a plurality of fins 421 disposed vertically, and an insulation circuit 422 is coated and formed on a lateral surface of the heat dissipating module 420 away from the fins 421 for electrically connecting the LED 130 (The heat dissipating module 420 also may comes with one or more grooves for embedding the reflecting unit which is the same as the heat dissipating module 210 of the second preferred embodiment, or forms a reflecting unit on an internal lateral side of the groove which is the same as the heat dissipating module 310 of the third preferred embodiment, and an insulation circuit coated on the bottom surface of the groove). In the meantime, the insulation circuit 422 forms a plurality of penetrating holes, and the heat dissipating module 420 is installed inside the base 411, and the fins 421 of the heat dissipating module 420 are partially exposed from an external side of the automotive lamp set 410; the thermoelectric cooling chip 430 has both lateral sides contacted with an object, and the thermoelectric cooling chip 430 is characterized in that if the thermoelectric cooling chip 430 is electrically connected to electric power, one of the lateral surfaces of the thermoelectric cooling chip 430 will produce a specific high temperature, which is called a hot end, and another lateral side produces a specific low temperature, which is called a cold end. On the other hand, if the hot end of the thermoelectric cooling chip 430 is heated directly or the cold end of the thermoelectric cooling chip is cooled, then a temperature difference will be formed at the hot end and cold end of the thermoelectric cooling chip 430, and the thermoelectric cooling chip 430 will produce electric power. In this embodiment, the hot end of the thermoelectric cooling chip 430 is attached onto the exposed fin 421 at the external side of the base 411 of the automotive lamp set 410; the rectification circuit 440 is electrically connected to the thermoelectric cooling chip 430, and the rectification circuit 440 is a bridge rectification circuit; the heat dissipating fan 450 is electrically connected to the rectification circuit 440, and the heat dissipating fan 430 is installed inside the automotive lamp set 410 and fixed under the fins 421 of the heat dissipating module 420, and an air outlet of the heat dissipating fan 450 faces the portion of fins 411 situated inside the automotive lamp set 410.

During installation, the plurality of LEDs 130 are electrically connected to the insulation circuit 422 of the heat dissipating module 420, so that the metal conducting plate 132 of the LED 130 is passed through the penetrating hole of the insulation circuit 422, such that the metal conducting plate 132 and the heat dissipating module 420 are in contact with each other, and the heat dissipating module 420 is fixed inside the automotive lamp set 410, and the insulation circuit 422 is electrically connected to an automotive LED lamp driving circuit (not shown in the figure) of the automobile body, and the fin 421 of the heat dissipating module 420 is passed through the through hole 4114 of the base 411, so that the fin 421 is partially exposed from an external side of the automotive lamp set 410, and then the hot end of the thermoelectric cooling chip 430 is attached onto the exposed fin 411 at an external side of the automotive lamp set 410. In the meantime, the thermoelectric cooling chip 430 is electrically connected to the rectification circuit 440 at the exterior of the base 411 of the automotive lamp set 410 (wherein the rectification circuit 440 also can be situated inside the base 411), and the rectification circuit 440 is electrically connected to the heat dissipating fan 450 installed inside the automotive lamp set 410, and then the groove 141 of the reflecting unit 140 corresponds with the LED 130, and the reflecting unit 140 is connected to the heat dissipating module 420, so that the LED 130 is situated at the bottom of the groove 141 of the reflecting unit 140, and finally the lamp housing 412 is fixed at the front of the automotive lamp set 410 to complete the installation of the automotive LED lamp 400. In the meantime, the automotive LED lamp 400 is mounted to the automobile body.

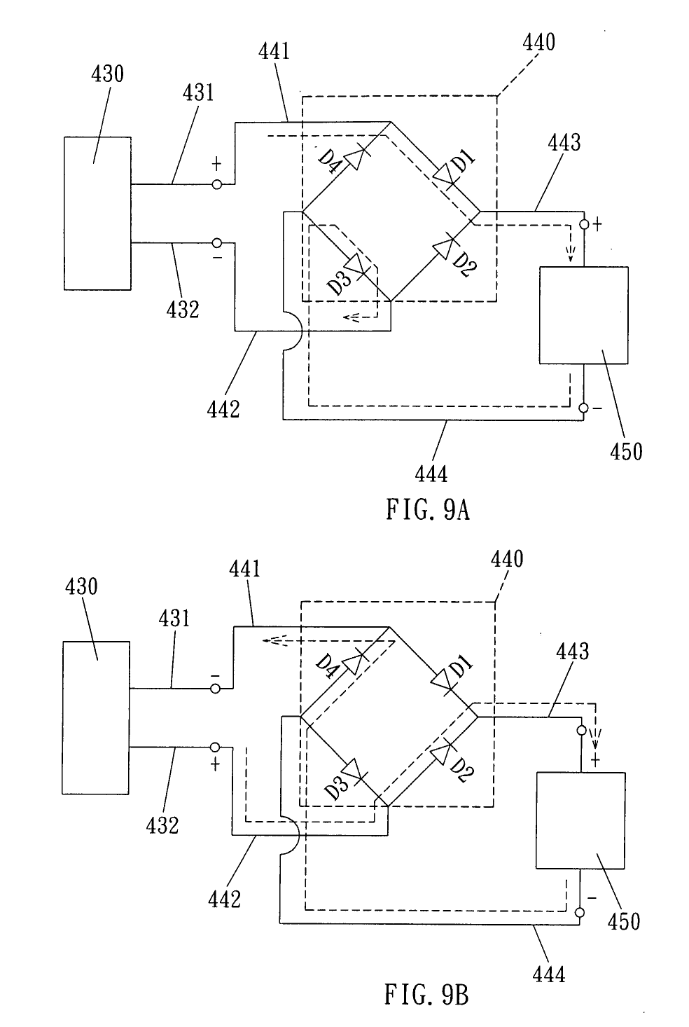

During use, the LED 130 is electrically connected to produce light, and the light is reflected by the reflecting unit 140, and refracted towards the lamp housing 412 to the outside, such that the position of the projected light can comply with the brightness and light pattern as set forth in the related laws and regulations of the automotive lamp. In the meantime, the LED 130 also process heat energy. The heat energy of the LED 130 is conducted by the metal conducting plate 132 of the LED 130 to the heat dissipating module 420, and the heat at the hot end of the thermoelectric cooling chip 430 is conducted by the heat dissipating module 420, and some of the heat energy are absorbed by the fin 421, and thus the temperature of the fin 421 drops. In the meantime, the heat energy at the hot end of the thermoelectric cooling chip 430 is absorbed, and thus a temperature difference is produced at the hot end and cold end of the thermoelectric cooling chip 430 to produce electric energy, wherein a first output terminal 431 of the thermoelectric cooling chip 430 has a positive electric potential, and a first input terminal 441 of the rectification circuit 440 is connected electrically. In the meantime, a second output terminal 432 of the thermoelectric cooling chip 430 has a negative electric potential, and a second input terminal 442 of the rectification circuit 440 is connected electrically (as shown in FIG. 9A, and the rectification circuit 440 is a bridge rectification circuit, and the dotted arrow head in the figure indicates the direction of current), such that a first rectifier D1 and a third rectifier D3 of the rectification circuit 440 are conducted electrically. In the meantime, a second rectifier D2 and a fourth rectifier D4 are in a cutoff state, so that a first output terminal 443 of the rectification circuit 440 has a positive electric potential, and the second output terminal 444 has a negative electric potential, and the heat dissipating fan 450 is connected electrically for its operation. The cold air enters from an air-guide channel 4111 of the base 411 into the automotive lamp set 410, and an air outlet of the heat dissipating fan 450 faces towards the fin 421, such that the cold air can absorb the heat energy of the fin 421 and discharge the air with the absorbed heat energy towards a ventilation hole 4112 of the base 411. If the temperature at a position where the thermoelectric cooling chip 430 is located (such as an engine room) is higher than the surface temperature of the heat dissipating module 420, then the lateral surface where the thermoelectric cooling chip 430 and the fin 421 of the heat dissipating module 420 are in contact is a cold end, and another lateral side of the thermoelectric cooling chip 430 is a hot end, and a temperature difference is formed at the hot end and cold end of the thermoelectric cooling chip 430 to produce electric power. Now, a first output terminal 431 of the thermoelectric cooling chip 430 has a negative electric potential, and a first input terminal 441 of the rectification circuit 440 is connected electrically. In the meantime, a second output terminal 432 of the thermoelectric cooling chip 430 has a positive electric potential, and a second input terminal 442 of the rectification circuit 440 is connected electrically (as shown in FIG. 9B, and the rectification circuit 440 is a bridge rectification circuit, and the dotted arrow head in the figure indicates the direction of current), such that a second rectifier D2 and a fourth rectifier D4 of the rectification circuit 440 are conducted electrically. In the meantime, a first rectifier D1 and a third rectifier D3 are in a cutoff state, so that a first output terminal 443 of the rectification circuit 440 also maintains a positive electric potential, and the second output terminal 444 also maintains a negative electric potential, and the heat dissipating fan 450 is connected electrically for its operation, and cold air enters from an air-guide channel 4111 of the base 411 into the automotive lamp set 410, and an air outlet of the heat dissipating fan 450 faces the fin 421, such that cold air absorbs the heat energy of the fin 421, and the air with absorbed heat energy is discharged towards a ventilation hole 4112 of the base 411 to the outside.

The larger the temperature difference at the cold and hot ends of the thermoelectric cooling chip 430, the more is the electric energy so produced, and thus the faster is the rotational speed of the heat dissipating fan 450. On the other hand, the smaller the temperature difference at the cold and hot ends of the thermoelectric cooling chip 430, the smaller is the electric energy so produced, and thus the smaller is the rotational speed of the heat dissipating fan 450. This embodiment can achieve an internal cooling circulation effect of the automotive lamp set 410 and maintain the heat dissipating module 420 at a stable temperature state.

The fifth preferred embodiment of the present invention is partially the same as the first preferred embodiment, and thus the same elements are represented by the same respective numerals and assumed to have identical structures and functions, unless stated otherwise.

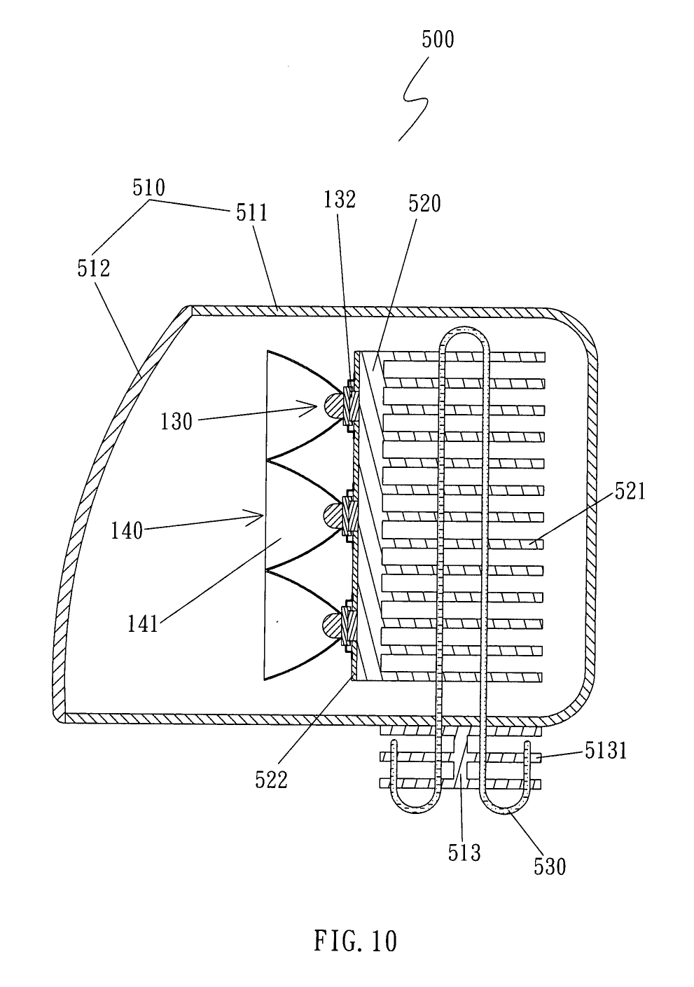

Referring to FIG. 10 a cross-sectional view of a heat dissipating apparatus for automotive LED lamp in accordance with a fifth preferred embodiment of the present invention, the automotive LED lamp 500 of the fifth preferred embodiment comprises an automotive lamp set 510, a heat dissipating module 520, a plurality of LEDs 130, a reflecting unit 140 and at least one heat pipe 530 (only one heat pipe 530 is adopted in this embodiment as shown in the figure), wherein the main difference resides on that the automotive lamp set 510 includes a base 511 and a lamp housing 512, and an external side of the base 511 has an accessory heat dissipating module 513, and the accessory heat dissipating module 513 has a plurality of fins 5131, and the fins 5131 have one or more through holes are for passing the heat pipe 530, and the automotive lamp set 510 at an appropriate position has a through hole for passing the heat pipe 530, and the heat dissipating module 520 is fixed inside the base 511, and the heat dissipating module 520 has a plurality of fins 521, and each fin 521 has one or more through holes for passing the heat pipe 530, and the heat dissipating module 520 has an insulation circuit 522 coated and formed on a lateral surface away from the fin 521 for electrically connecting the LED 130 (the heat dissipating module 520 can be the same heat dissipating module 210 as the second preferred embodiment having one or more grooves for embedding the reflecting unit or the same heat dissipating module 310 as the third preferred embodiment forming a reflecting unit at the internal side of the groove and an insulation circuit coated at the bottom surface of the groove). In the meantime, the insulation circuit 522 forms a plurality of penetrating holes, and the heat pipe 530 is passed through the through hole of the fins 521 of the heat dissipating module 520 and extended into the through hole of the base 511 correspondingly, such that the heat pipe 530 can be passed through the through hole of the fin 5131 of an accessory heat dissipating module 513 that is disposed at an external side of the base 511.

During installation, the plurality of LEDs 130 are electrically connected to the insulation circuit 522 of the heat dissipating module 520, and the metal conducting plate 132 of the LED 130 is passed through the penetrating hole of the insulation circuit 522, such that the metal conducting plate 132 and the heat dissipating module 520 are in contact with each other, and then the heat pipe 530 is passed through the through hole of the fin 521 of the heat dissipating module 520. In the meantime, the heat dissipating module 520 is fixed inside the automotive lamp set 510, and the insulation circuit 522 is electrically connected to an automotive LED lamp driving circuit (not shown in the figure) of the automobile body, and another end of the heat pipe 530 is passed through the through hole of the automotive lamp set 510, and the heat pipe 530 is extended into the through hole of the fin 5131 of the accessory heat dissipating module 513 which is disposed at an external side of the automotive lamp set 510, and the groove 141 of the reflecting unit 140 corresponds with the LED 130, so that the reflecting unit 140 is connected to the heat dissipating module 520, and the LED 130 is situated at the bottom of the groove 141 of the reflecting unit 140, and finally the lamp housing 512 is fixed at the front of the automotive lamp set 510 to complete the installation of the automotive LED lamp 500. In the meantime, the automotive LED lamp 500 is mounted at the automobile body.

During use, the LED 130 is electrically connected to produce light, and the light is reflected from the reflecting unit 140, and refracted towards the lamp housing 512 to the outside, such that the position of the projected light can comply with the brightness and light pattern as set forth in the related laws and regulations of the automotive lamp. In the meantime, the LED 130 also produces heat energy. The heat energy of the LED 130 is conducted through a metal conducting plate 132 of the LED 130 to the heat dissipating module 520, and a portion of a heat pipe 530 of the fin 521 installed at the heat dissipating module 520 is a hot region, and the heat pipe 530 installed at the fin 5131 of the accessory heat dissipating module 513 of the automotive lamp set 510 is a cooling region. After the heat energy of the heat dissipating module 520 at the heat pipe 530 is absorbed, the fluid in the heat pipe 530 is vaporized due to the rise of surface temperature, flowed from the hot region to the cooling region in the heat pipe, and then condensed into a liquid state. In the meantime, the latent heat of vapor is released, so that the heat pipe 530 can achieve the heat dissipating effect of the heat dissipating module 520.

The sixth preferred embodiment of the present invention is partially the same as the first preferred embodiment, and thus the same elements are represented by the same respective numerals and assumed to have identical structures and functions, unless stated otherwise.

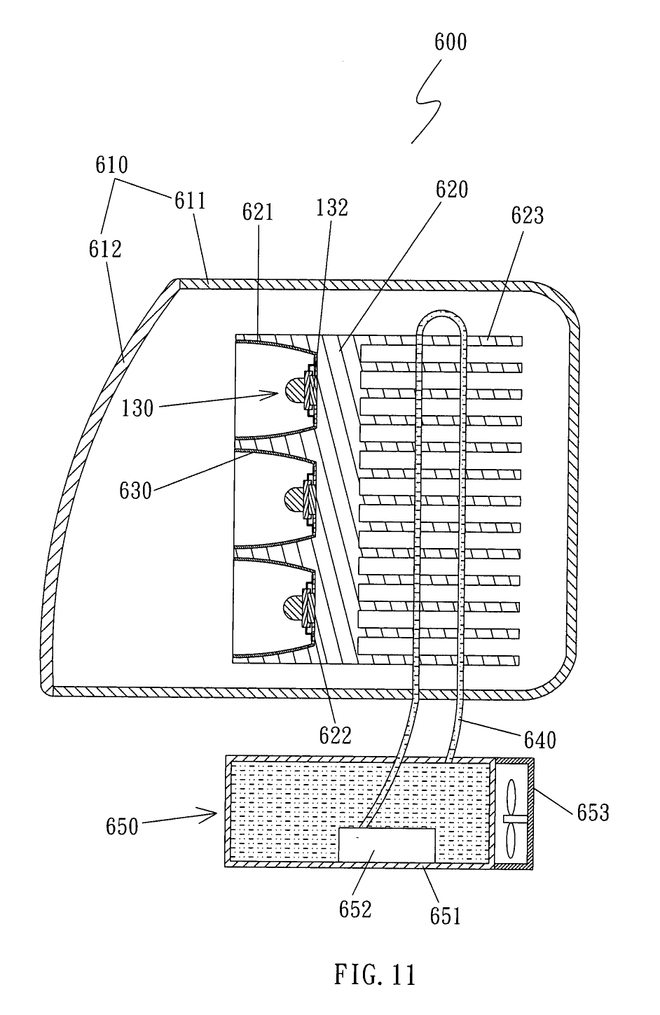

Referring to FIG. 11 for a schematic view of a heat dissipating apparatus for automotive LED lamp in accordance with a sixth preferred embodiment of the present invention, the automotive LED lamp 600 of the sixth preferred embodiment comprises an automotive lamp set 610, a heat dissipating module 620, a plurality of LEDs 130, a plurality of reflecting units 630, at least one thermal conducting pipe 640 and a cooling module 650, wherein the main difference resides on that the automotive lamp set 610 includes a base 611 and a lamp housing 612, and the base 611 is provided for containing and installing the heat dissipating module 620, and the bottom surface of the base 611 has one or more through holes for passing the thermal conducting pipe 640. The heat dissipating module 620 is consisted of one or more grooves 621, and an insulation circuit 622 is coated and formed at the bottom surface of the groove 621 for electrically connecting the LED 130. In the meantime, the insulation circuit 622 forms a penetrating hole (wherein the heat dissipating module 620 can be the same heat dissipating module 120 as the first preferred embodiment having an insulation circuit 622 coated and formed at an appropriate position of the heat dissipating module 620, and the insulation circuit 622 forms a plurality of penetrating holes), and the heat dissipating module 310 has a plurality of fins 623, and each fin 623 has a through hole. The reflecting unit 630 is electroplated on an internal lateral surface of the groove 621 of the heat dissipating module 620, such that the light projected by the LED 130 is reflected by the reflecting unit 630, and refracted towards the lamp housing 612 to the outside, such that the position of the projected light can comply with the brightness and light pattern as set forth in the related laws and regulations of the automotive lamp (wherein the reflecting unit 630 also can be the same reflecting unit 140 as the first preferred embodiment having a plurality of grooves 141, and the LED 130 is situated at the bottom surface of the groove 141, or the same reflecting unit 140 as the second preferred embodiment being embedded into the groove 621 of the heat dissipating module 620). The thermal conducting pipe 640 is passed in and out through the through hole of the fin 623 of the heat dissipating module 620 and connected to the cooling module 650. The cooling module 650 includes a storage device 651 for storing a liquid coolant, and a pump 652 installed inside the storage device 651, and an external side of the storage device 651 has a heat dissipating fan 653, and the pump 652 is connected to an end of the thermal conducting pipe 640, such that the pump 652 can be operated to flow the liquid coolant of the storage device 651 between the thermal conducting pipe 640 and the storage device 651.

During installation, the plurality of LEDs 130 are electrically connected to the insulation circuit 622 at the groove 621 of the heat dissipating module 620, and the metal conducting plate 132 of the LED 130 is passed through the penetrating hole of the insulation circuit 622, such that the metal conducting plate 132 and the heat dissipating module 620 are in contact with each other, and then the thermal conducting pipe 640 is passed through the through hole of the fin 623 of the heat dissipating module 620, and then the heat dissipating module 620 is fixed inside the automotive lamp set 610, and the insulation circuit 622 is electrically connected to an automotive LED lamp driving circuit (not shown in the figure) of the automobile body, and both ends of the thermal conducting pipe 640 are passed through the through hole of the base 611 at the same time. Both ends of the thermal conducting pipe 640 are connected to the storage device 651 and the pump 652 respectively, and finally the lamp housing 612 is fixed at the front of the base 611 to complete the installation of the automotive LED lamp 600. In the meantime, the automotive LED lamp 600 is mounted at the automobile body.

During use, the LED 130 is electrically connected to produce light, and the light is reflected by a reflecting unit 630 formed at the groove 621 of the heat dissipating module 620 and refracted towards the lamp housing 612 to the outside, such that the position of the projected light can comply with the brightness and light pattern as set forth in the related laws and regulations of the automotive lamp. In the meantime, the LED 130 also produces heat energy. The heat energy of the LED 130 is conducted from a thermal conducting plate 132 of the LED 130 to the heat dissipating module 620. The pump 652 is operated to flow the liquid coolant stored in the storage device 651 into the thermal conducting pipe 640. If the liquid coolant in the thermal conducting pipe 640 flows through the fins 623 of the heat dissipating module 620, the liquid coolant absorbs the heat energy of the fins 623, and also returns he liquid coolant with the absorbed heat energy to the storage device 651, and an heat dissipating fan 653 at an external side of the storage device 651 blows air to dissipate heat of the storage device 651, so that the heat dissipating module 620 can perform repeated circulation to achieve the heat dissipating effect.

The seventh preferred embodiment of the present invention is partially the same as the first preferred embodiment, and thus the same elements are represented by the same respective numerals and assumed to have identical structures and functions, unless stated otherwise.

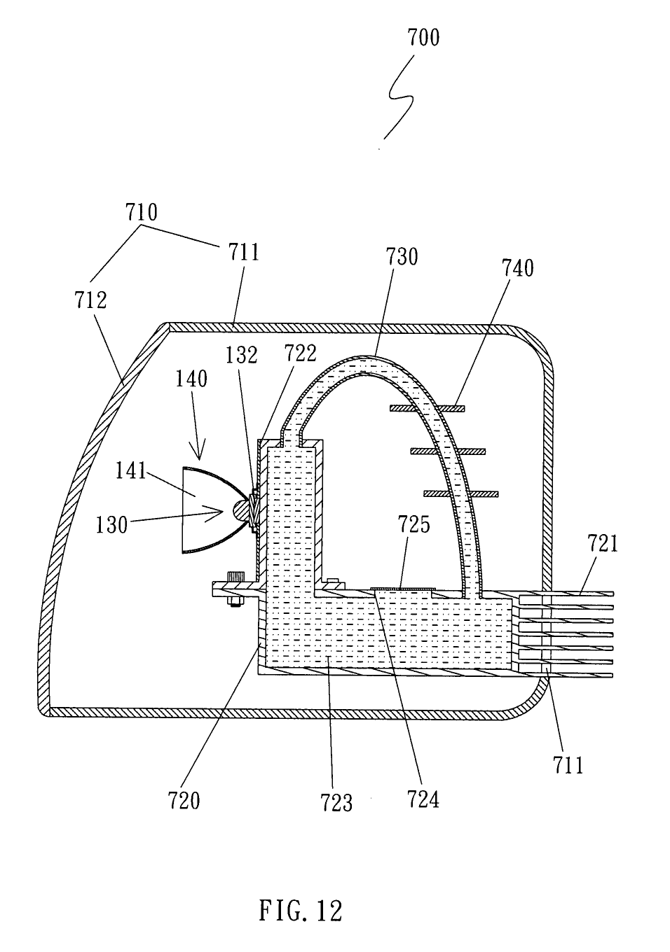

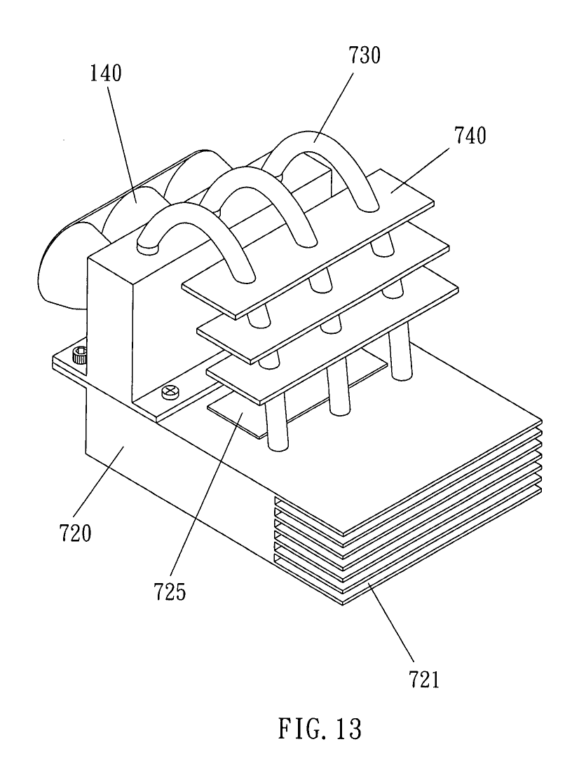

Referring to FIGS. 12 and 13 for a cross-sectional view of a heat dissipating apparatus for automotive LED lamp in accordance with a seventh preferred embodiment of the present invention and a perspective view of a heat dissipating module and a reflecting unit in accordance with the present invention, the automotive LED lamp 700 of the seventh preferred embodiment comprises an automotive lamp set 710, a heat dissipating module 720, a plurality of LEDs 130, a reflecting unit 140, at least one thermal conducting pipe 730 and a plurality of thermal conducting plates 740, wherein the main difference resides on that the automotive lamp base 710 includes a base 711 and a lamp housing 712, and the base 711 is provided for containing and installing the heat dissipating module 720, and an rear lateral side of the base 711 has a through hole 7111 disposed at an appropriate position for passing the heat dissipating module 720. The heat dissipating module 720 has a plurality of fins 721, and an insulation circuit 722 coated and formed on a lateral surface of the heat dissipating module 720 away from the fin 721 for electrically connecting the LED 130 (wherein the heat dissipating module 720 can be the same heat dissipating module 210 as the second preferred embodiment having one or more grooves for embedding the reflecting unit, or the same heat dissipating module 310 as the third preferred embodiment forming a reflecting unit at an internal lateral side of the groove, and the bottom surface of the groove is coated with the insulation circuit). In the meantime, the insulation circuit 722 forms a plurality of penetrating holes, and the heat dissipating module 720 has a containing space 723 for containing a liquid coolant, and the heat dissipating module 720 has an opening 724 at an appropriate position, and the opening 724 has a rubber plate 725 for producing a specific liquid pressure for the liquid coolant in the heat dissipating module 720 due to the thermal expansion. With the elasticity of the rubber plate 725, the liquid pressure produces an expansion force to the rubber plate 725 for adjusting the liquid pressure of the liquid coolant. The thermal conducting pipe 730 is made of a metal material, and both ends of the thermal conducting pipe 730 are fixed at the heat dissipating module 720, such that the liquid coolant in the containing space 723 of the heat dissipating module 720 flows freely in the containing space 723 between the thermal conducting pipe 730 and the heat dissipating module 720 due to the siphon effect. The thermal conducting plate 740 has a through hole for passing the thermal conducting pipe 730, and the thermal conducting plate 740 is fixed at the thermal conducting pipe 730.

During installation, the plurality of LEDs 130 are electrically connected to the insulation circuit 722 of the heat dissipating module 720, and the metal conducting plate 132 of the LED 130 is passed through the penetrating hole of the insulation circuit 722, such that the metal conducting plate 132 and the heat dissipating module 720 are in contact with each other, and then the thermal conducting pipe 730 has a plurality of the metal conducting plate 740, and the thermal conducting pipe 730 is fixed at the heat dissipating module 720, and then a liquid coolant is filled into a containing space 723 of the heat dissipating module 730, and the heat dissipating module 720 is fixed inside the automotive lamp base 710, and the insulation circuit 722 is electrically connected to an automotive LED lamp driving circuit (not shown in the figure) of the automobile body, and the groove 141 of the reflecting unit 140 corresponds to the LED 130, so that the reflecting unit 140 is connected to the heat dissipating module, and the LED 130 is situated at the bottom of the groove 141 of the reflecting unit 140 (wherein the reflecting unit 140 as shown in FIG. 13 has three grooves 141 arranged in a row, but the number of LEDs 130 and grooves of the reflecting unit 140 are not limited to a row or three only), and finally the lamp housing 712 is fixed at the front of the automotive lamp base 710 to complete the installation of the automotive LED lamp 700. In the meantime, the automotive LED lamp 700 is mounted at the automobile body.

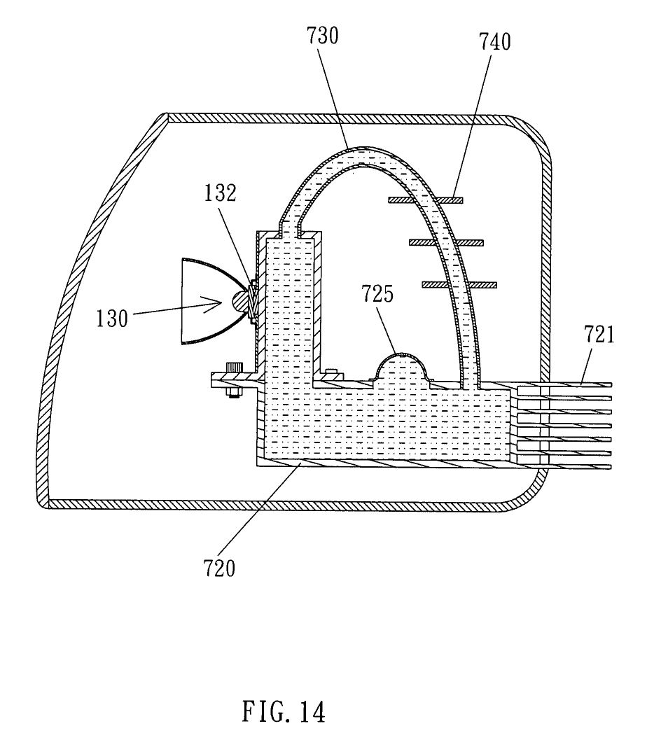

During use, the LED 130 is electrically connected to produce light, and the light is reflected from the reflecting unit 140 and refracted towards the lamp housing 712 to the outside, such that the position of the projected light can comply with the brightness and light pattern as set forth in the related laws and regulations of the automotive lamp. In the meantime, the LED 130 also produces heat energy. The heat energy of the LED 130 is conducted from the metal conducting plate 132 of the LED 130 to the heat dissipating module 720, and the liquid coolant in the heat dissipating module 720 is heated to expand and form a specific liquid pressure, such that the liquid pressure produces an expansion force on the rubber plate 725 (as shown in FIG. 14) to adjust the pressure in the containing space 723 of the heat dissipating module 720, and the fins 721 are disposed at an external side of the automotive lamp base 710. With contact of the fins 721 with cold air, the heat energy is absorbed by the cold air, for lowering the temperature of the heat dissipating module 720. In the meantime, the heat energy absorbed by the liquid coolant is conducted through the thermal conducting pipe 730 to the metal conducting plate 740, so that the metal conducting plate 740 can exchange heat with the external cold air, and the metal conducting plate 740 can be used for dissipating heat, and the liquid coolant inside the heat dissipating module 720 can flow in the containing space 723 between the thermal conducting pipe 730 and the heat dissipating module 720 due to the siphon effect, so as to achieve the cooling and heat dissipating effect by the heat dissipating module 720.

The eighth preferred embodiment of the present invention is partially the same as the first preferred embodiment, and thus the same elements are represented by the same respective numerals and assumed to have identical structures and functions, unless stated otherwise.

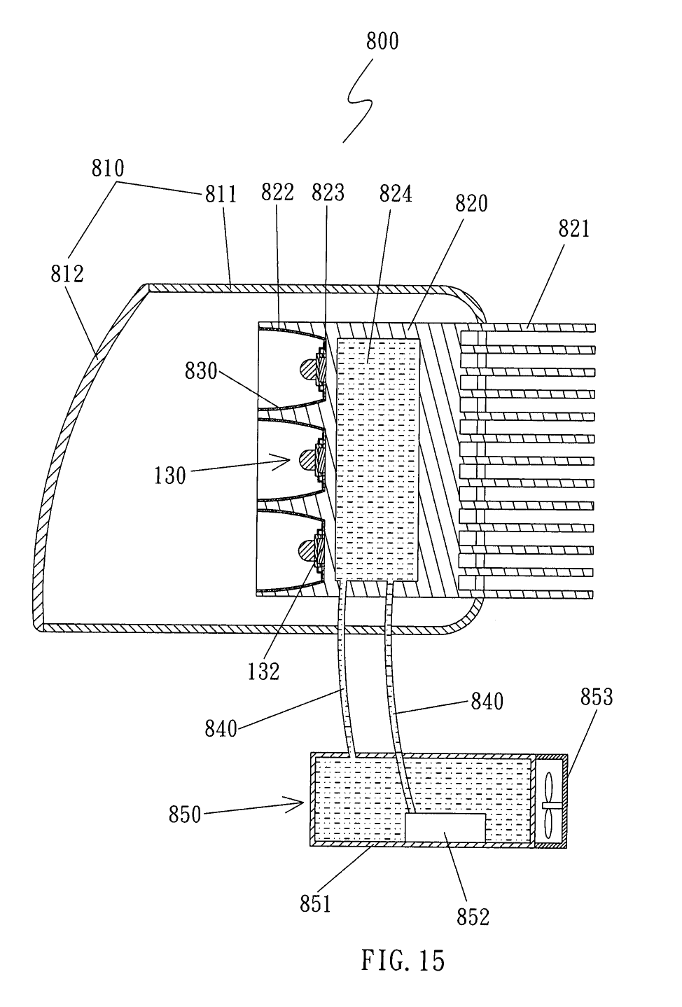

Referring to FIG. 15 for a cross-sectional view of a heat dissipating apparatus for automotive LED lamp the eighth preferred embodiment in accordance with the present invention, the main difference of the eighth preferred embodiment resides on that the automotive LED lamp 800 comprises an automotive lamp set 810, a heat dissipating module 820, a plurality of LEDs 130, a plurality of reflecting units 830, two thermal conducting pipes 840 and a cooling module 850, wherein the automotive lamp set 810 includes a base 811 and a lamp housing 812, and the base 811 is provided for containing and installing the heat dissipating module 820, and the bottom surface of the automotive lamp set 810 has one or more through holes for passing the thermal conducting pipe 840; the heat dissipating module 820 has a plurality of fins 821, and the heat dissipating module 820 has a plurality of grooves 822 disposed at appropriate positions, and an insulation circuit 823 is coated and formed at the bottom surface of the groove 822 for electrically connecting the LED 130 (wherein the heat dissipating module 820 can be the same heat dissipating module 210 as the second preferred embodiment having a groove 211). In the meantime, the insulation circuit 823 has a penetrating hole, and the heat dissipating module 820 has a containing space 824 for containing a liquid coolant; the reflecting unit 830 is electroplated at an internal lateral side of a groove 822 of the heat dissipating module 820, such that the light projected by the LED 130 can be reflected from the reflecting unit 830 and refracted towards the lamp housing 812 to the outside, and the light is projected at an appropriate position (wherein the reflecting unit 830 can be the same reflecting unit 140 as the first preferred embodiment having a plurality of grooves 141, and the LED 130 is situated at the bottom surface of the groove 141, or the same reflecting unit 140 as the second preferred embodiment being embedded into the groove 621 of the heat dissipating module 620); the thermal conducting pipe 840 is fixed to the heat dissipating module 820, such that the thermal conducting pipe 840 is electrically conducted with the containing space 824 of the heat dissipating module 820, and the thermal conducting pipe 840 is connected to the cooling module 850. The cooling module 850 includes a storage device 851 for storing a liquid coolant, and a pump 852 installed inside the storage device 851, and an external side of the storage device 851 has a heat dissipating fan 853, and the pump 852 is connected to the thermal conducting pipe 840, for pouring the liquid coolant from the storage device 851 to the containing space 824 of the heat dissipating module 820.

During installation, the plurality of LEDs 130 are electrically connected to the insulation circuit 823 of the heat dissipating module 820, and the metal conducting plate 132 of the LED 130 is passed through the penetrating hole of the insulation circuit 823, so that the metal conducting plate 132 and the heat dissipating module 820 are in contact with each other, and the insulation circuit 823 is electrically connected to a driving circuit of the automobile body, and then the heat dissipating module 820 is fixed inside the base 811, and two thermal conducting pipes 840 are connected to the heat dissipating module 820, and the thermal conducting pipe 840 is passed through the through hole 811 of the automotive lamp set 810, so that the thermal conducting pipe 840 is connected to the storage device 851, and the pump 852 inside the storage device 851 is connected to one of the thermal conducting pipes 840, and the insulation circuit 823 is electrically connected to an automotive LED lamp driving circuit (not shown in the figure) of the automobile body, and finally the lamp housing 812 is fixed at the front of the base 811 to complete the installation of the automotive LED lamp 800. In the meantime, the automotive LED lamp 800 is mounted at the automobile body.

During use, the LED 130 is electrically connected to produce light, and the light is reflected from the reflecting unit 140, and refracted towards the lamp housing 812 to the outside, such that the position of the projected light can comply with the brightness and light pattern as set forth in the related laws and regulations of the automotive lamp. In the meantime, the LED 130 also produces heat energy. The heat energy of the LED 130 is conducted from the metal conducting plate 132 of the LED 130 to the heat dissipating module 820. With the operation of the pump 852 of the cooling module 850, the liquid coolant stored in the storage device 851 is poured from the thermal conducting pipe 840 to the containing space 824 of the heat dissipating module 820. In the meantime, heat energy is absorbed into the heat dissipating module 820, and the liquid coolant in the containing space 824 returns from another thermal conducting pipe 840 to the storage device 851, and the heat dissipating fan 853 at an external side of the storage device 851 blows air at the storage device 851 for dissipating heat, so as to repeatedly cool the heat dissipating module 820 for the heat dissipating effect.

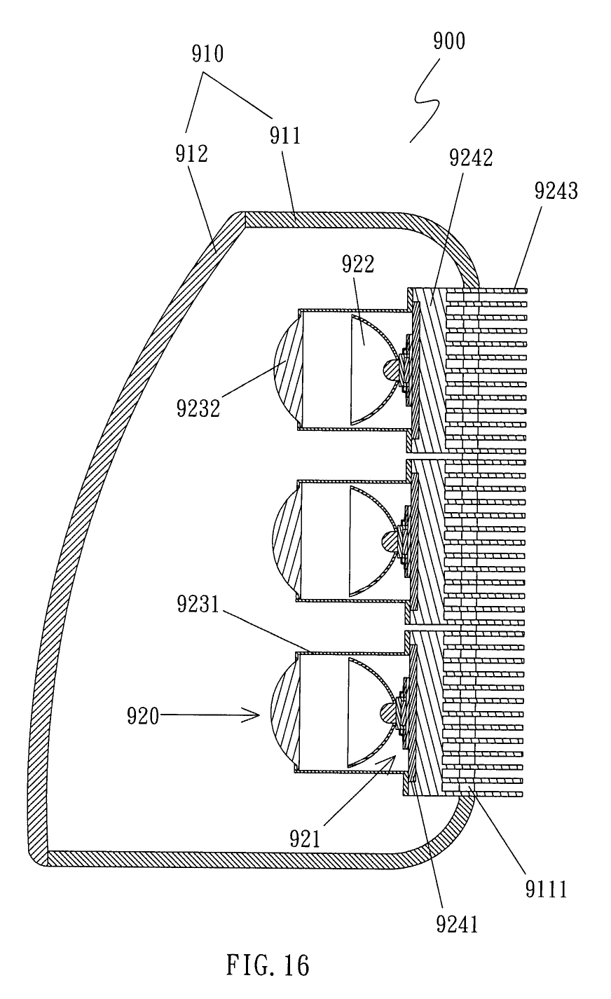

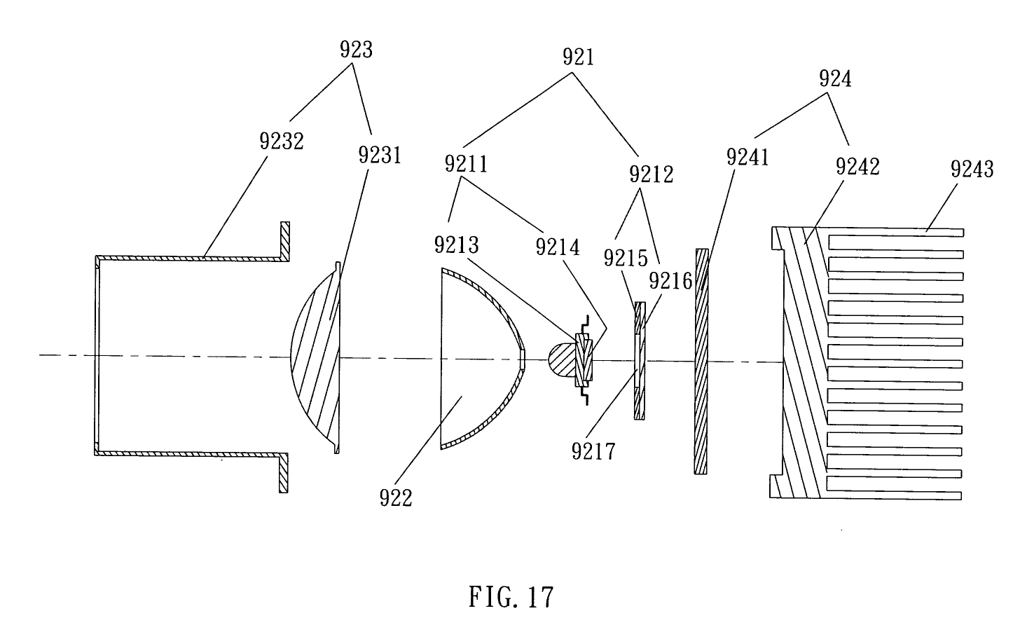

Referring to FIGS. 16 and 17 for a cross-sectional view of a heat dissipating apparatus for automotive LED lamp and a cross-sectional view of a light emitting module in accordance with a ninth preferred embodiment of the present invention respectively, the automotive LED lamp 900 of the ninth preferred embodiment includes an automotive lamp set 910 and a plurality of light emitting modules 920, wherein the main difference resides on that the automotive lamp set 910 is fixed at the automobile body, and the automotive lamp set 910 includes a base 91 land a lamp housing 912, and the base 911 has one or more through holes 9111 disposed at an appropriate position (wherein this embodiment only has one through hole 9111), and the lamp housing 912 can be a light transmitting body; the light emitting module 920 is fixed inside the base 911 of the automotive lamp set 910, and the light emitting module 920 includes a light emitting unit 921, a reflecting unit 922, a lens unit 923, and a heat dissipating unit 924, and the light emitting unit 921 includes an LED 9211 and a substrate 9212, and the LED 9211 has a main base 9213, and the main base 9213 has a metal conducting plate 9214, and the substrate 9212 is made by connecting a circuit board 9215 with a heat sink 9216, and the circuit board 9215 is provided for electrically connecting the LED 9211, and the middle of the circuit board 9215 has a penetrating hole 9217, such that when the LED 9211 is electrically connected to the circuit board 9215, the metal conducting plate 9214 of the LED 9211is passed through the penetrating hole 9217, and the heat sink 9216 are in contact with each other; the reflecting unit 922 is provided for installing the light emitting unit 921 at the bottom of the reflecting unit 922, for reflecting the light projected by the LED 9211 from the reflecting unit 922; the lens unit 923 is installed at the front of the reflecting unit 922, and the lens unit 923 includes a lens 923 land a fixing frame 9232 for fixing the lens 9231, and the fixing frame 9232 is connected to the heat dissipating unit 924; the heat dissipating unit 924 is connected to the light emitting unit 921 and the fixing frame 9232, and the heat dissipating unit 924 includes a thermoelectric cooling chip 9241 and a heat dissipating base 9242, and the thermoelectric cooling chip 9241 has both lateral sides, such that if the thermoelectric cooling chip 9241 is electrically connected to an electric power, one of the lateral sides of the thermoelectric cooling chip 9241 produces a specific high temperature, and such lateral side is called a hot end, and another lateral side also produces a specific low temperature, and such lateral side is called a cold end. If the hot end of the thermoelectric cooling chip 9241 is heated directly, or the cold end of the thermoelectric cooling chip is cooled, for producing a temperature difference between the cold and hot ends of the thermoelectric cooling chip 9241, then the thermoelectric cooling chip 430 will produce electric energy. The cold end of the thermoelectric cooling chip 420 is connected to a substrate 9212 of the light emitting unit 921, and both are in contact with each other for lowering the temperature produced by the light emitting unit 921; the heat dissipating base 9242 is made of a metal material, ceramic or other material with a high thermal conduction coefficient and connected to the hot end of the thermoelectric cooling chip 9241, and both are in contact with each other, for lowering the temperature produced by the body of the thermoelectric cooling chip 9241, and for connecting the fixing frame 9232, and the heat dissipating base 9242 has a plurality of fins 9243.

During installation, the LEDs 9211 are electrically connected to a circuit board 9215of the substrate 9212, and the metal conducting plate 132 of the LED 130 is passed through a penetrating hole 9217 of the circuit board 9215 and attached onto a heat sink 9216 of the substrate 9212 to constitute the light emitting unit 921, and then the light emitting unit 921 is connected to the thermoelectric cooling chip 9241, such that the heat sink 9216 of the light emitting unit 921 and a low-temperature lateral side of the thermoelectric cooling chip 9241 are in contact with each other, and the thermoelectric cooling chip 9241 is connected to the heat dissipating base 9242, and the reflecting unit 922 and the LED 9211 of the light emitting unit 921 are installed correspondingly, such that the LED 9211 is installed at the bottom of the reflecting unit 922, and the lens unit 923 is installed at the front of the reflecting unit 922, and fixed by the fixing frame 9232 and the heat dissipating base 9242 to complete the installation of a single light emitting module 920; and finally a plurality of light emitting modules 920 are fixed to the base 911. In the meantime, the fin 9243 of the heat dissipating base 9242 corresponds to the through hole 9111 of the base 911, and the fins 9243 are disposed on the external side of the base 911, such that the circuit board 9215, the thermoelectric cooling chip 9241 is electrically connected to and an automotive LED lamp driving circuit (not shown in the figure) of the automobile body, and the lamp housing 912 is connected to the base 911 to complete the installation of the automotive LED lamp 900. In the meantime, the automotive LED lamp 900 is mounted at the automobile body.

During use, the LED 9211 is electrically connected to produce light, and the light is reflected from the reflecting unit 922, and refracted towards the lens unit 923. In the meantime, the LED 9211 also produces heat energy. The heat energy of the LED 9211 is conducted by the metal conducting plate 9214 of the LED 9211 to the heat sink 9216, and the heat sink 9216 is contacted directly with the cold end of the thermoelectric cooling chip 9241, so that the thermoelectric cooling chip 9241 can absorb the heat energy of the heat sink 9216. The hot end of the thermoelectric cooling chip 9241 is in a direct contact with the heat dissipating base 924, such that the high-temperature heat of the thermoelectric cooling chip 9241 is conducted to the heat dissipating base 9242, and the fin 9243 situated at the external side of the base 911 exchanges heat with the external cold air for dissipating the heat by the heat dissipating base 9242, so as to achieve the heat dissipating effect of the light emitting module 920.

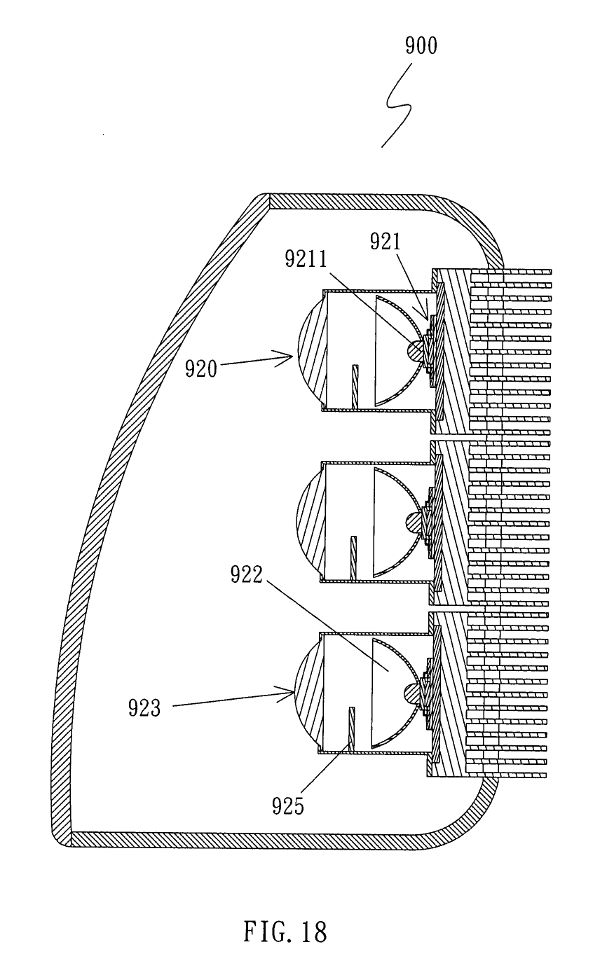

The light emitting module 920 of the ninth preferred embodiment has a movable shading unit 925 disposed between the reflecting unit 922 and the lens unit 923 as shown in FIG. 18 for forming a specific light pattern by the shading unit 925 through the light projected by the LED 9211 of the light emitting unit 921, or switching the far and near lamps.

The tenth preferred embodiment of the present invention is partially the same as the first preferred embodiment, and thus the same elements are represented by the same respective numerals and assumed to have identical structures and functions, unless stated otherwise.

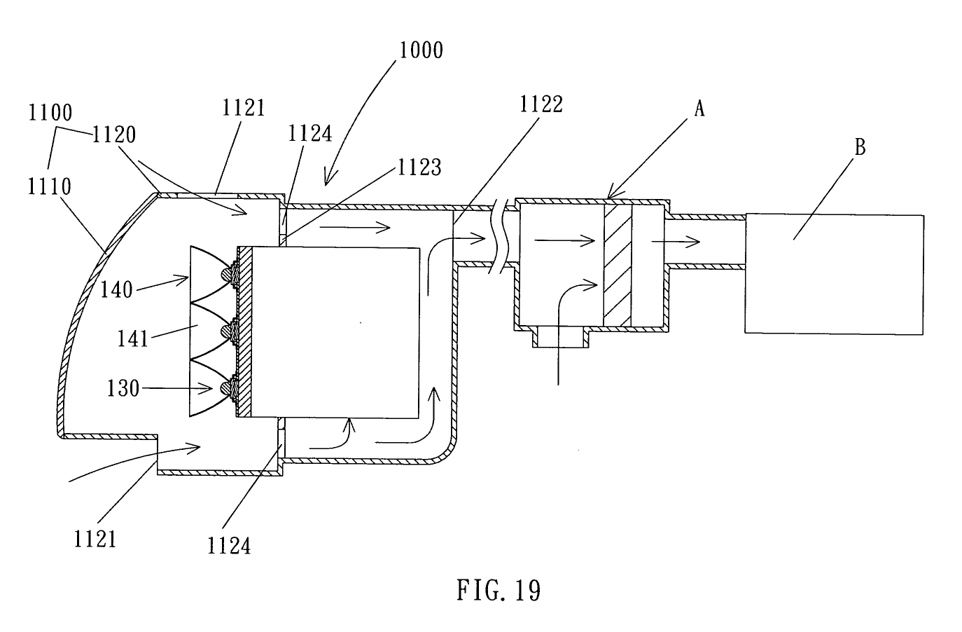

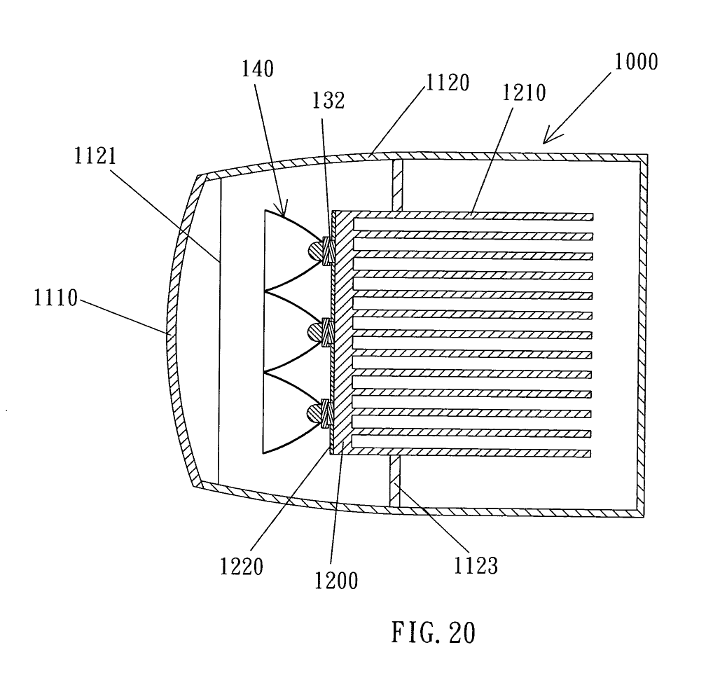

Referring to FIGS. 19 and 20 for a cross-sectional view of a heat dissipating apparatus for automotive LED lamp in accordance with a tenth preferred embodiment, and a horizontal cross-sectional view of an automotive LED lamp of the present invention respectively, the automotive LED lamp 1000 of the tenth preferred embodiment comprises an automotive lamp set 1100, a heat dissipating module 1200, a plurality of LEDs 130 and a reflecting unit, wherein the main difference resides on that the automotive LED lamp 1000 is connected to an air filter A of the automobile body, and the air filter A is connected to an engine B of the automobile body. The automotive lamp set 1100 of the automotive LED lamp 1000 includes a lamp housing 1110 and a base 1120, and the lamp housing 1110 is fixed at the front of the base 1120, and the base 1120 is provided for containing and installing the heat dissipating module 1200, and the base 1120 has one or more air inlet louver 1121, and the base 1120 has a penetrating hole 1122 at an appropriate position for connecting the air filter A, and the base 1120 has a fixed partition 1123 at an appropriate position therein, and the fixed partition 1123 has a through hole for positioning the heat dissipating module 1200, and the fixed partition 1123 has at least one penetrating hole 1124 at an appropriate position (wherein this embodiment adopts two penetrating holes 1124) for flowing air. The heat dissipating module 1200 is installed and fixed to the through hole of the fixed partition 1123 correspondingly, and the heat dissipating module 1200 has a plurality of fins 1210 disposed vertically, and an insulation circuit 1220 coated and formed on a lateral surface of the heat dissipating module 1200 away from the fin 1210 for electrically connecting the LED 130 (wherein the heat dissipating module 1200 can be the same heat dissipating module 210 as the second preferred embodiment having one or more grooves for embedding the reflecting unit, or the same heat dissipating module 310 as the third preferred embodiment, and the reflecting unit is formed at the internal lateral side of the groove, and the insulation circuit is coated at the bottom surface of the groove bottom surface). In the meantime, the insulation circuit 1220 forms a plurality of penetrating holes.

During installation, the plurality of LEDs 130 are electrically connected to an insulation circuit 1220 of the heat dissipating module 1200, and the metal conducting plate 132 of the LED 130 is passed through the penetrating hole of the insulation circuit 1220, such that the metal conducting plate 132 and the heat dissipating module 1200 are in contact with each other, and the insulation circuit 1220 is electrically connected to an automotive LED lamp driving circuit (not shown in the figure) of the automobile body, and then the heat dissipating module 1200 is fixed at a fixed partition 1123 of the automotive lamp set 1100, and then the groove 141 of the reflecting unit 140 and the LED 130 are installed correspondingly, such that the LED 130 can be situated at the bottom of the groove 141 of the reflecting unit 140, and the reflecting unit 140 is connected to the heat dissipating module 1200, and the LED 130 is installed at the bottom of the groove 141 of the reflecting unit 140, and finally the lamp housing 1110 is fixed at the front of the automotive lamp set 1100 to complete the installation of the automotive LED lamp 1000. In the meantime, the automotive LED lamp 1000 is connected to the air filter, and the automotive LED lamp 1000 is mounted at the automobile body.

During use, the LED 130 is electrically connected to produce light, and the light is reflected from the reflecting unit 140, and refracted towards the lamp housing 1110 to the outside, such that the position of the projected light can comply with the brightness and light pattern as set forth in the related laws and regulations of the automotive lamp. In the meantime, the LED 130 also produces heat energy. The heat energy of the LED 130 is conducted by the thermal conducting plate 132 of the LED 130 to the heat dissipating module 1200. In the meantime, an engine B of the automobile body is operated to produce a vacuum suction for sucking the air from the air filter A, so that the external cold air can be introduced from an air inlet louver 1121 of the automotive lamp set 1100 into the automotive lamp set 1100 and through the penetrating hole 1124 towards the air filter A to constitute an air flow, and thus the heat energy of the heat dissipating module 1200 can be absorbed by the cold air flowing inside the automotive lamp set 11000. Even if the automobile is still or the engine B of the automobile is idle, the vacuum suction remains, so that an appropriate amount of cold air will pass through the heat dissipating module 1200 and its fins 1210, and constitute a compulsory air flow towards the air filter A.

In summation of the description above, the present invention has the following advantages:

The heat dissipating apparatus for automotive LED lamp of the invention adopts cold air or a liquid coolant as the heat dissipating medium for the heat dissipating module to achieve the effect of dissipating the heat produced by the LED, so that the LED of the automotive LED lamp will not reduce its light output or cause damages due to the overheat, and thus the life expectancy of the automotive LED lamp can be extended.

In summation of the above description, the overall assembly and characteristics of the present invention herein enhance the performance than the conventional structure and further complies with the patent application requirements and is duly filed for a patent application.

While the invention has been described by means of specific embodiments, numerous modifications and variations could be made thereto by those skilled in the art without departing from the scope and spirit of the invention set forth in the claims.

What is claimed is:

1. A heat dissipating apparatus for automotive LED lamp, fixed to an automobile body, and electrically connected to an automotive LED lamp driving circuit in the automobile body, and the automotive LED lamp comprising:
an automotive lamp set having a base and a lamp housing which is a light transmitting body fixed at a front of the base;
a heat dissipating module connected to the base of the automotive lamp set and having a plurality of fins so as to form an insulation circuit in the heat dissipating module, such that the insulation circuit is not electrically connected with a body of the heat dissipating module;
a plurality of LEDs electrically connected to the insulation circuit of the heat dissipating module and each the LED having a main base, the main base having a metal conducting plate so as to conduct heat energy produced by the LEDs to the heat dissipating module; and
a reflecting unit installed inside the base of the automotive lamp set and fixed to the bottom of the reflecting unit so as to reflect a light projected from the LEDs and refracting the light towards the lamp housing.

2. The heat dissipating apparatus for automotive LED lamp as claimed in claim 1, wherein the heat dissipating module includes one or more grooves, and an insulation circuit is disposed at the bottom surface of the groove for electrically connecting the LED, and the reflecting unit forms one or more grooves, such that the groove of the reflecting unit corresponds to the groove of the heat dissipating module for embedding and fixing the groove of the reflecting unit into the groove of the heat dissipating module.

3. The heat dissipating apparatus for automotive LED lamp as claimed in claim 1, wherein the heat dissipating module includes a plurality of grooves and an insulation circuit is disposed at the bottom of the groove for electrically connecting the LED, the reflecting unit is electroplated onto an inner lateral surface of the groove.

4. The heat dissipating apparatus for automotive LED lamp as claimed in claim 1, wherein the automotive lamp base has a through hole for mounting the insulation circuit of the heat dissipating module towards the automotive lamp base and situating the fin of the heat dissipating module at an external side of the automotive lamp base.

5. The heat dissipating apparatus for automotive LED lamp as claimed in claim 1, wherein the automotive lamp base includes at least one air-guide channel and at least one ventilation hole, and the fin of the heat dissipating module includes a plurality of thermoelectric cooling chips electrically connected to one or more heat dissipating fans, and the heat dissipating fans are mounted at appropriate positions inside the automotive lamp base, and the heat dissipating fan has an air outlet facing towards the fin of the heat dissipating module for heating thermoelectric cooling chip to supply electric energy, and operating the heat dissipating fan.

6. The heat dissipating apparatus for automotive LED lamp as claimed in claim 5, wherein the base of the automotive lamp set has a through hole disposed at an appropriate position, for situating a portion of the fin of the heat dissipating module at an external side of the base, and the thermoelectric cooling chip is fixed onto the fin on an external side of the base.

7. The heat dissipating apparatus for automotive LED lamp as claimed in claim 5, further comprising at least one rectification circuit electrically connected between the thermoelectric cooling chip and the heat dissipating fan.

8. The heat dissipating apparatus for automotive LED lamp as claimed in claim 1, wherein the heat dissipating module is fixed inside a base of the automotive lamp set, and the plurality of fins of the heat dissipating module separately include one or more through holes, and one or more heat pipes passing the through holes of the fins respectively.

9. The heat dissipating apparatus for automotive LED lamp as claimed in claim 8, wherein the automotive lamp set includes a heat dissipating module installed at an external side of the base of the automotive lamp set, and the heat dissipating module has a plurality of fins, and the fin has a through hole for passing the heat pipe, so that another end of the heat pipe installed at the heat dissipating module inside the base of the automotive lamp set is extended and passed through the through hole of the heat dissipating module at an external side of the base of the automotive lamp set.

10. The heat dissipating apparatus for automotive LED lamp as claimed in claim 1, wherein the plurality of fins of the heat dissipating module separately have one or more through holes, and the through hole of the fin is provided for passing at least one or more than one thermal conducting pipe, and a cooling module is connected separately to both ends of the thermal conducting pipe.

11. The heat dissipating apparatus for automotive LED lamp as claimed in claim 10, wherein the cooling module includes a storage device for storing a liquid coolant, and a pump installed inside the storage device and connected to an end of the thermal conducting pipe and operated to drive the liquid coolant of the storage device to flow between the thermal conducting pipe and the storage device.

12. The heat dissipating apparatus for automotive LED lamp as claimed in claim 11, wherein the storage device has at least one heat dissipating fan mounted onto an external side of the storage device for dissipating heat for the storage device.

13. The heat dissipating apparatus for automotive LED lamp as claimed in claim 1, wherein the heat dissipating module has a containing space therein, for containing the liquid coolant, and the heat dissipating module is connected to one or more thermal conducting pipes, and both ends of the thermal conducting pipe have the heat dissipating modules respectively, such that the liquid coolant flows between the thermal conducting pipe and the containing space of the heat dissipating module.

14. The heat dissipating apparatus for automotive LED lamp as claimed in claim 13, wherein the heat dissipating module has an opening disposed at an appropriate position, and a rubber plate installed at the opening for adjusting a pressure change of the liquid coolant in the containing space of the heat dissipating module due to an expansion at hot temperature or a contraction at cold temperature by the elasticity of the rubber plate.

15. The heat dissipating apparatus for automotive LED lamp as claimed in claim 13, wherein the thermal conducting pipe installs a plurality of thermal conducting plates.

16. The heat dissipating apparatus for automotive LED lamp as claimed in claim 2, wherein the heat dissipating module has a containing space therein for containing a liquid coolant, and the heat dissipating module is connected to two or more thermal conducting pipes, and another end of the each thermal conducting pipe is connected to the cooling module, and the cooling module includes a storage device for storing the liquid coolant and a pump installed inside the storage device, and the storage device is connected to one of the thermal conducting pipes, and the pump is connected to another thermal conducting pipe, for pumping the liquid coolant from the storage device to the containing space of the heat dissipating module by the operation of the pump.

17. The heat dissipating apparatus for automotive LED lamp as claimed in claim 16, wherein the storage device includes at least one heat dissipating fan mounted on an external side of the storage device, for dissipating heat for the storage device.

18. The heat dissipating apparatus for automotive LED lamp as claimed in claim 1, wherein the automotive LED lamp is connected to an air filter of the automobile body, and the air filter is connected to an engine of the automobile body, and a base of the automotive LED lamp includes one or more air inlet louvers, the base has a penetrating hole disposed at an appropriate position for connecting the air filter, for forming a vacuum suction when the engine operates, while sucking air filtered by the air filter, such that the heat energy produced by the automotive LED lamp is dissipated to the air filter from the penetrating hole.

19. A heat dissipating apparatus for automotive LED lamp, fixed at an automobile body, and electrically connected to an automotive LED lamp driving circuit in the automobile body, and the automotive LED lamp comprising:
an automotive lamp set including a base and a lamp housing, the lamp housing being a light transmitting body fixed at a front of the base;
a plurality of light emitting modules fixed to a base of the automotive lamp set, the each light emitting module including a light emitting unit, a reflecting unit, a lens unit and a heat dissipating unit, the light emitting unit including an LED and a substrate, the substrate is comprised of a circuit board and a heat dissipating board, the circuit board being electrically connected to the LED, the reflecting unit being provided for installing the light emitting unit at the bottom of the reflecting unit and reflecting light projected by the LED, the lens unit being installed at the front to the reflecting unit, the heat dissipating unit being fixed to the light emitting unit, the heat dissipating unit including a thermoelectric cooling chip and a heat dissipating fin, the thermoelectric cooling chip being coupled to the light emitting unit for lowering temperature of the light emitting unit, the heat dissipating fin being coupled to the thermoelectric cooling chip for lowering the temperature of a body of the thermoelectric cooling chip.

20. The heat dissipating apparatus for automotive LED lamp as claimed in claim 19, wherein the base of the automotive lamp set installs one or more through holes at an appropriate position for situating a heat dissipating fin of the light emitting module at an external side of the base of the automotive lamp set.

21. The heat dissipating apparatus for automotive LED lamp as claimed in claim 19, further comprising a movable shading unit installed between the reflecting unit and the lens unit for driving the automotive LED lamp to project a predetermined light pattern.
